(19) United States
(12) Patent Application Publication
(10) Pub. No.: US 2007/0046902 A1
(43) Pub. Date: Mar. 1, 2007

(54) Projector device

(75) Inventor: Kenichi Yajima, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/508,845

(22) Filed: Aug. 24, 2006

(30) Foreign Application Priority Data
Aug. 29, 2005 (JP) 2005-247364

(51) Int. Cl. G03B 21/14; G03B 21/00

(52) U.S. Cl. 353/70

(57) ABSTRACT

An embodiment of the invention, a projector device having a trapezoidal distortion correction mode of projected video and including, a distance measurement sensor which obtains a distance to a screen and a tilt angle, a lens barrel which projects the projected video, and a zoom ring attached to the lens barrel by use of one embodiment of this invention, an irradiation position from the distance measurement sensor to the screen is changed based on a position of the zoom ring, so that a detection precision of the tilt angle of the screen can be enhanced.

### CROSS-REFERENCE TO RELATED APPLICATIONS

This application is based upon and claims the benefit of priority from Japanese Patent Application No. 2005-247364, filed Aug. 29, 2005, the entire contents of which are incorporated herein by reference.

### BACKGROUND

1. Field

One embodiment of the invention relates to a projector device including an automatically key stone (trapezoidal) distortion correction mode of projected video.

2. Description of the Related Art

A projector device including a trapezoidal distortion correction mode of projected video is put to practical use.

When a screen on which a projected image is displayed is not perpendicular to a projected direction of the projected image, the projected image is trapezoidally distorted. The trapezoidal distortion correction mode is a function of correcting the trapezoidally distorted image into a rectangular image. As correcting methods, there are a manual method and an auto key stone (automatic trapezoidal distortion correction). In the auto key stone, a distance measurement sensor is used which obtains a distance to the screen and a tilt angle of the screen with respect to the projected direction of the projected video.

For example, Japanese Patent Application Publication (KOKAI) No. 2004-134908, a system is disclosed in which the distance measurement sensor is rotated in a range of −20 degrees to +20 degrees, and distance measurement is performed every degree. However, as many as 41 rotation angle detection elements (photo interrupters or the like) are installed to stop the sensor every degree, and therefore the system is mechanically large-scaled, which leads to the increase of cost. A long distance measurement time is required. Furthermore, this method has a restriction that it is impossible to detect the tilt angle which is not less than a rotation angle (±20 degrees) of the distance measurement sensor. That is, in the projector device provided with the auto key stone of the Japanese Patent Application Publication (KOKAI) No. 2004-134908, it is known that when the auto key stone is performed, the detectable tilt angle is limited and the long distance measurement time is required.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a schematic block diagram of a projector device in accordance with an embodiment of the invention;

FIG. 2 is an exemplary diagram showing an example of schematic diagram of a method of detecting a direction of a distance measurement sensor in accordance with an embodiment of the invention;

FIG. 3 is an exemplary diagram showing an example of a schematic diagram of a rotation angle of the distance measurement sensor and an irradiation position of infrared ray in accordance with an embodiment of the invention;

FIG. 4 is an exemplary diagram showing an example of a schematic diagram of a method of calculating a screen tilt angle of a projector device shown in FIG. 1 in accordance with an embodiment of the invention; and

FIG. 5 is an exemplary flow chart showing an example of a schematic diagram of an operation of a projector device shown in FIG. 1 in accordance with an embodiment of the invention.

### DETAILED DESCRIPTION

Various embodiments according to the invention will be described hereinafter with reference to the accompanying drawings. In general, according to one embodiment of the invention, a projector device including a trapezoidal distortion correction mode of projected video, comprising: an optical system which projects the video toward a screen; a distance measurement sensor provided with the optical system which obtains a distance from the optical system to the screen; a tilt angle obtaining unit which obtains a tilt angle of the screen from a projected direction of the projected video based on the distance; a zoom operation unit attached to the optical system which operations a zoom operation of the projected video; and a controller which controls an irradiation range from the distance measurement sensor to the screen, there are set three points in total including two points on opposite ends of the projected video on the screen and the center of the projected video, and the controller which informs in a case where it is detected that the outside of the screen is irradiated with an infrared ray of either of the opposite ends.

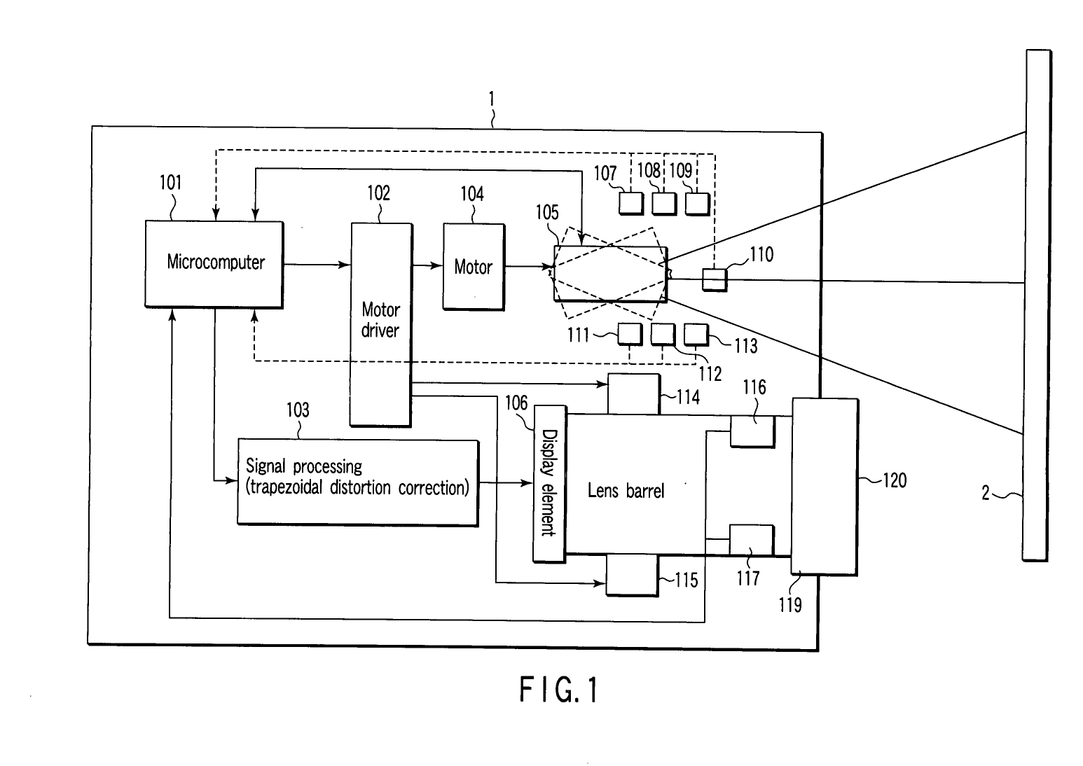

According to an embodiment, a projector device of the invention will be described in FIGS. 1 to 5.

In an automatically key stone (trapezoidal) distortion correction, in many cases, a horizontal direction and a vertical direction are implementing objects, respectively, but in the present embodiment, the present invention will be described in accordance with the horizontal direction as the example.

FIG. 1 is a schematic block diagram of the projector device in the present invention. In a projector 1, to realize projection of video subjected to the automatically key stone (trapezoidal) distortion correction with respect to a screen 2, a microcomputer 101 which controls the whole device controls: a motor driver 102 which individually controls three types of motors; and a signal processing section 103 which performs the automatically key stone (trapezoidal) distortion correction. A motor 104 for a distance measurement sensor, for changing an irradiation direction of an infrared ray, rotates a distance measurement sensor 105 of an infrared ray system (in response to an instruction (providing of a control amount) from the motor driver 102).

Moreover, the projector 1 is constituted of: a display element 106 which projects a video signal from the signal processing section 103 onto the screen 2; rotation angle detection elements 107 to 113 of the distance measurement sensor 105; a focus ring control motor 114; a zoom ring control motor 115; an element 116 which detects a focal position; an element 117 which detects a zoom position; and a lens barrel 118 to which the focus ring control motor 114 and the zoom ring control motor 115 are attached. A zoom ring 119 is zoom operation means by a user or the projector device, and the lens barrel 118 is optical system means for projecting the projected video.

Next, an operation in FIG. 1 will be described. The distance measurement sensor 105 of the infrared ray system irradiates the screen 2 with the infrared ray in response to an instruction from the microcomputer 101. Moreover, the infrared ray projected to the screen is received by a light receiving element of the distance measurement sensor 105, a distance to the screen is obtained, and a result is returned to the microcomputer 101. It is to be noted that as the light receiving element, a position sensitive device (PSD) is general, but another device may be used.

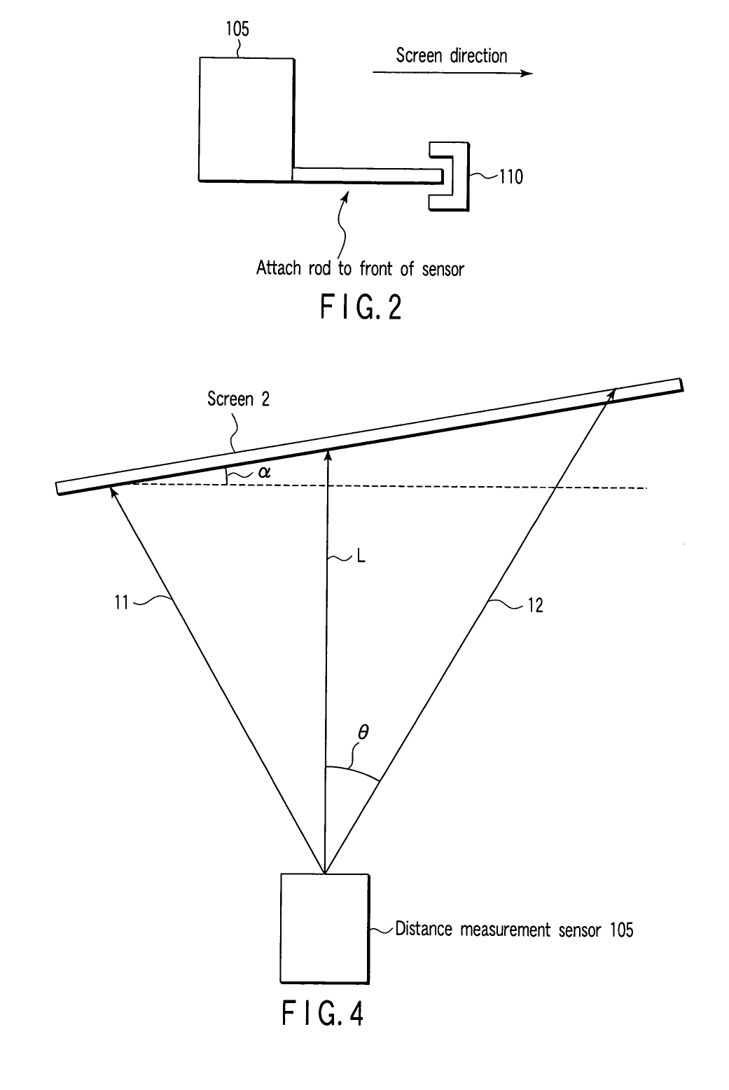

After a power supply of the projector 1 is turned on, the microcomputer 101 sets the distance measurement sensor 105 in a direction (i.e., a rotation angle on a set front is 0 degree) parallel to an optical axis of the lens barrel 118 by use of the detection element 110. As the detection element, it is general to use a transmissive photo interrupter, and one method is shown in FIG. 2. That is, a rotation angle detecting rod is attached to the front of the distance measurement sensor 105. This rod is attached in the same direction as that of the sensor 105. When the sensor 105 is directed in parallel with the optical axis of the lens barrel 118, this rod is inserted between an LED light emitting portion and a light receiving portion in the detection element 110, and it is detected that the sensor is directed in parallel as described above. The microcomputer 101 can receive the signal as interruption to judge that the sensor 105 is directed as described above, and stops the motor 104 at this time. The other detection elements 107 to 109 and 111 to 113 can be realized by a similar mechanism.

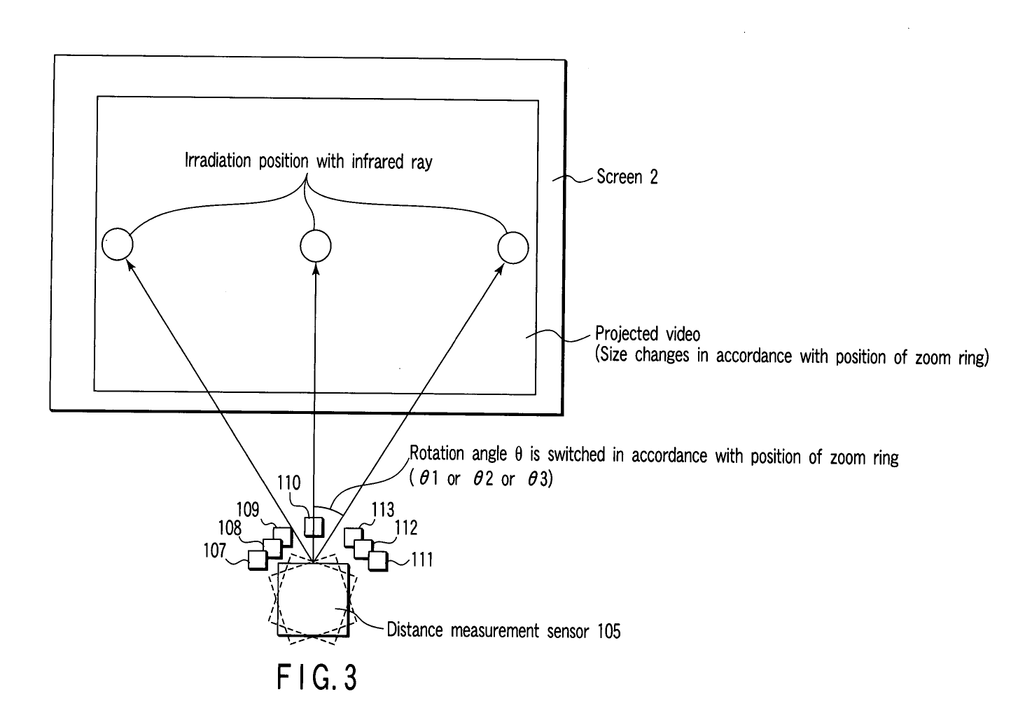

Moreover, the other detection elements 107 to 109 and 111 to 113 are installed as follows. First, the elements 109 and 113 are installed in a position where an inner edge of an image frame of the projected video is irradiated with the infrared ray, even when the zoom ring moves to a telephoto end (maximum telephoto side) shown in FIG. 3. At this time, the rotation angle of the sensor 105 is set to ±θ1. For example, it is assumed that when the detection element 113 detects the rod of the lower portion of the distance measurement sensor, the sensor tilts at +θ1 degrees with respect to the optical axis of the lens barrel 118. It is similarly assumed that when the detection element 109 detects the rod, the sensor tilts at −θ1 degrees with respect to the optical axis. Similarly, the detection elements 108 and 112 are installed in a position where the inside of the image frame of the projected video is irradiated with the infrared ray, when the zoom ring moves to the center between a wide-angle end (maximum wide-angle side) and the telephoto end. This angle is set to ±θ2. Finally, the detection elements 107 and 111 are installed in a position where the inner edge of the image frame of the projected video is irradiated with the infrared ray, when the zoom ring moves to the wide-angle end. This angle is set to ±θ3. Therefore, among the angles, a relation of |±θ1|<|±θ2|<|±θ3| is established (0<θ1<θ2<θ3).

Moreover, the microcomputer 101 rotates the zoom motor 115 to move the zoom ring 119 via the motor driver 102 in response to the instruction from the user. During the rotation of the motor, via the zoom position detection element 117, the microcomputer 101 can detect a rotation direction and count the number of rotations to thereby monitor a position of the zoom ring 119. Accordingly, the microcomputer 101 can constantly grasp the position of the zoom ring 119, and the result is held in an RAM built in the microcomputer. It is to be noted that the detection element 117 is usually realized by a combination of a reflective photo interrupter which detects a default position (usual wide-angle end) and a two-phase transmissive photo interrupter which detects the rotation direction and the rotation number. The focal position detection element 116 has the same constitution.

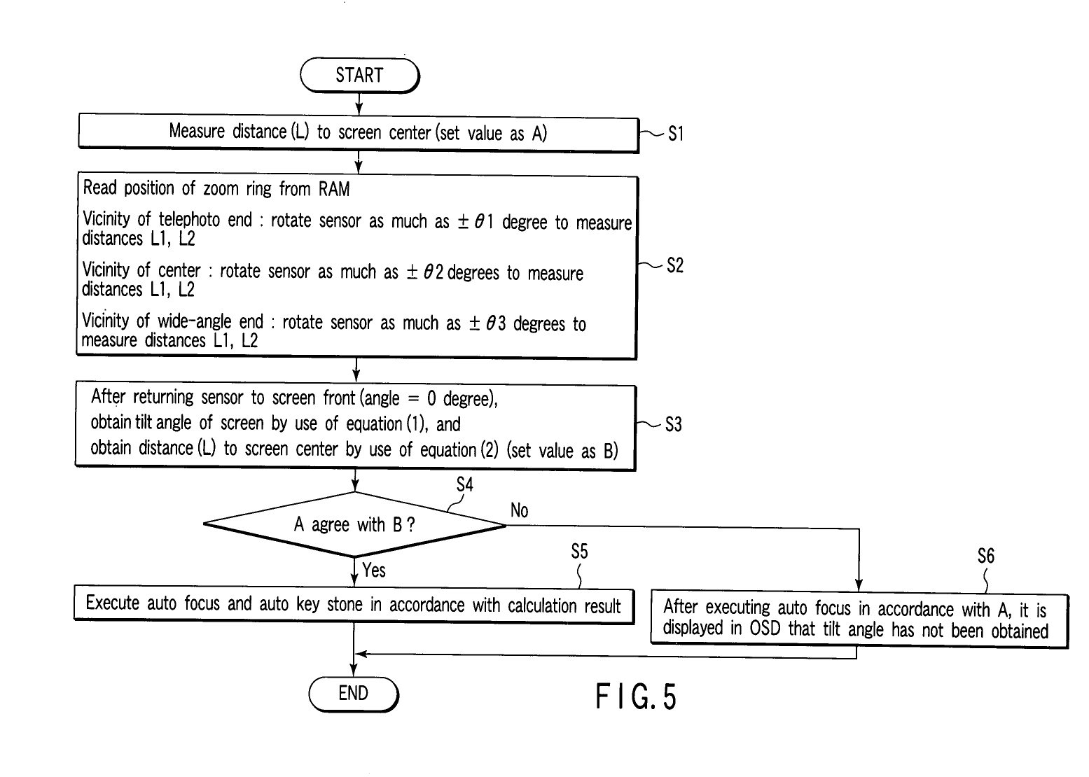

The one of the present embodiment will be described hereinafter with reference to a flow chart of an auto focus and auto key stone operation (see FIG. 5). When the user instructs execution of the auto focus and auto key stone with a key of a remote controller or the projector 1, or when a setting is performed beforehand, after turning on the power supply of the projector 1, the microcomputer 101 instructs the distance measurement sensor 105 to measure distances. The sensor is set to be parallel to (i.e., the rotation angle is 0 degree) the optical axis in a default state, obtains a distance corresponding to L of FIG. 4, and returns a result to the microcomputer 101. This result is set as A.

Next, the microcomputer 101 reads the present position of the zoom ring from the RAM. It is assumed that a detection range (i.e., a movement range of the zoom ring) of the detection element 117 at a time when the zoom ring moves from the wide-angle end to the telephoto end is a value of 0 to 300 (the wide-angle end is set as 0, and the telephoto end is set to 300). When the value read from the RAM is in a range of 0 to 100, it is judged that the zoom ring is on the side of the wide-angle end, and the distance measurement sensor 105 is rotated as much as ±θ3 degrees to measure a distance between the opposite ends. Specifically, the motor 104 is controlled to rotate the sensor 105 until the detection element 107 detects the rotated disposed in the lower portion of the sensor 105. When the element 107 detects the rod, the motor 104 is stopped, and the sensor 105 is instructed to measure the distance. Accordingly, a distance L1 of FIG. 4 is obtained. Next, the motor 104 is controlled to rotate the sensor 105 until the detection element 111 detects the rod. When the element 111 detects the rod, the motor 104 is stopped, and the sensor 105 is instructed to measure the distance. Accordingly, a distance L2 of FIG. 4 is obtained. If the zoom position read from the RAM is in a range of 101 to 200, the sensor 105 is rotated as much as ±θ2 degrees to obtain the distances L1 and L2 to the screen by use of the detection elements 108 and 112. Similarly, when the zoom position indicates a value of 201 or more, it is judged that the zoom ring is on the side of the telephoto end, and the sensor 105 is rotated as much as ±θ1 degree to measure the distance between the opposite ends by use of the detection elements 109 and 113.

If the distances L1 and L2 are obtained, after returning the sensor 105 to the direction parallel to the optical axis by use of the detection element 110, a tilt angle ax of the screen is obtained by the following:
tan α=(L2·cos θ−L1·cos θ)/(L1·sin θ+L2·sin θ) (1),
wherein as θ, any of θ1 to θ3 described above is applied in accordance with the position of the zoom ring. Even when any of θ1 to θ3 is applied, the result tilt angle α is theoretically equal, but in actual, an error is included in the distance measurement result of the sensor 105. Therefore, especially in a case where the tilt angle of the screen is small, a difference between L1 and L2 is buried by this error, and there is a high possibility that a detection precision of the tilt angle is insufficient. As this measure, when the angle θ is set to be as large as possible, the difference between the distances L1 and L2 enlarges, and therefore the detection precision enhances, but a possibility rises that the irradiation position with the infrared ray deviates from the screen. To solve the problem, when the angle θ is changed in accordance with the position of the zoom ring as described above, the above problem can be solved. This is because it is usual for the user to adjust the zoom ring so that the projected video falls on the screen before viewing the video.

When the tilt angle α of the screen is obtained by the above equation (1), a distance L (distance to the center of the video) of FIG. 3 can be obtained by the following
L=L1(cos θ+sin θ·tan α) (2).

The distance L obtained by the above equation (2) is set as B.

Next, the result A is compared with B. If the screen is irradiated with the infrared ray, the values substantially agree with each other. If the values are largely different from each other, it can be judged that the infrared ray with which the opposite ends have been irradiated deviates from the screen. In this case, after obtaining an appropriate focal amount by use of the result A, the microcomputer 101 controls the focus motor 116 to execute the auto focus. Thereafter, the user is notified by an OSD or the like that a portion deviating outwardly from the screen is irradiated with the infrared ray, and the tilt angle cannot be obtained correctly. Conversely, when the value A substantially agrees with B, after performing the auto focus, the microcomputer controls the signal processing section 103 to perform the auto key stone in accordance with the detection angle obtained by the above equation (1).

In the present embodiment, one distance measurement sensor is installed in the device of the projector 1, and rotated to measure the distances to three points on the screen. Therefore, it is possible to solve a conventional problem that there are large restrictions on the distance measurement time and the detectable tilt angle. For example, assuming that θ1 nearly equals 11 degrees, θ2 nearly equals 13 degrees and θ3 nearly equals 15 degrees, the tilt angle α is detectable in a range of 40 degrees to 45 degrees. The following effects can be expected.

(1) The user adjusts the zoom ring so that the projected video falls in the screen. When the infrared ray irradiation position from the distance measurement sensor is changed in accordance with the position of the zoom ring, the outside of the screen is irradiated with the infrared ray, and an effect is obtained that the detection precision of the angle is enhanced while reducing a possibility that the tilt angle of the screen is mistaken.

(2) There are measured distances to three points in total: two points on the opposite ends of the projected video on the screen; and the video center. Accordingly, it can be judged whether or not one or both of the infrared rays with which the opposite ends have been irradiated has deviated from the screen. Therefore, there is obtained an effect that the trapezoidal correction is prevented from being performed in accordance with a wrong tilt angle, the only auto focus is executed using the distance to the video center, and an appropriate message can be notified to the user. This effect is especially remarkable in a case where the auto focus and auto key stone are executed in a state in which the projected video is not seen yet immediately after the power supply is turned on.

In one of the present embodiment, the only auto key stone in the horizontal direction has been described, but when the distance measurement sensor 105 and the angle detection elements 107 to 113 are installed rotatably in the vertical direction, the auto key stone in the vertical direction is also possible.

Moreover, there is also considered a method in which the auto key stone in a horizontal direction is constituted in the same manner as in the present embodiment, and the auto key stone in the vertical direction is realized by an acceleration sensor. In the method, for example, when the user vertically moves the projector 1, and the sensor detects that the movement stops, the auto key stone is performed.

Furthermore, in one of the present embodiment, the rotation angle is switched in three stages (θ1 to θ3), but the rotation angle may be set to arbitrary stages in accordance with convenience of the device. In the present embodiment, the infrared ray is used in the sensor, but there may be a modification in which ultrasonic waves and the like are used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projector device including a trapezoidal distortion correction mode of projected video, comprising:
an optical system which projects the video toward a screen;
a distance measurement sensor provided with the optical system which obtains a distance from the optical system to the screen;
a tilt angle obtaining unit which obtains a tilt angle of the screen from a projected direction of the projected video based on the distance;
a zoom operation unit attached to the optical system which operations a zoom operation of the projected video; and
a controller which controls an irradiation range from the distance measurement sensor to the screen, there are set three points in total including two points on opposite ends of the projected video on the screen and the center of the projected video, and the controller which informs in a case where it is detected that the outside of the screen is irradiated with an infrared ray of either of the opposite ends.

2. The projector device according to claim 1, wherein among the three irradiation points by the distance measurement sensor, the center is first irradiated, and next the either of the opposite ends and the other of opposite ends are irradiated.

3. A projector device including a trapezoidal distortion correction mode of projected video, comprising:
an optical system which projects the video toward a screen;
a distance measurement sensor provided with the optical system which obtains a distance from the optical system to the screen;
a tilt angle obtaining unit which obtains a tilt angle of the screen from a projected direction of the projected video based on the distance; and
a zoom operation unit attached to the optical system which operations a zoom operation of the projected video,
a controller which controls an irradiation range from the distance measurement sensor to the screen is set based on a position of the zoom operation unit.

4. The projector device according to claim 3, wherein a rotation angle of the distance measurement sensor is set to be small so that the irradiation range falls in an image frame of a projected screen at a time when the zoom operation unit is on the side of a teleconversion end, and the rotation angle of the distance measurement sensor is set to be larger so that an irradiation position meets the image frame of the projected screen at a time when the zoom operation unit is on the side of a wide-angle end.

5. The projector device according to claim 3, wherein the controller which controls in a case where an irradiation range from the distance measurement sensor to the screen, there are set three points in total including two points on opposite ends of the projected video on the screen and the center of the projected video, and it is detected that the outside of the screen is irradiated with an infrared ray of either of the opposite ends, and the controller which informs in a case where it is detected that the outside of the screen is irradiated with an infrared ray of either of the opposite ends.

6. The projector device according to claim 3, further comprising:
a motor driver controlled by the controller; and
a motor driven by the motor driver which rotates the distance measurement sensor in accordance with rotation of the motor to obtain a distance to a screen,
wherein in a case where as an irradiation range from the distance measurement sensor to the screen, there are set three points in total including two points on opposite ends of the projected video on the screen and the center of the projected video, and the controller which informs in a case where it is detected that the outside of the screen is irradiated with an infrared ray of either of the opposite ends.

7. A projector device including a trapezoidal distortion correction mode of projected video, comprising:
an optical system which projects the video toward a screen;
a distance measurement sensor which obtains a distance from the optical system to the screen with three points in total including two points on opposite ends of the projected video on the screen and the center of the projected video are set an irradiation range, and in a case where it is detected that the outside of the screen is irradiated with an infrared ray of either of the opposite ends, a user is notified that the outside of the screen has been irradiated;
a tilt angle obtaining unit which obtains a tilt angle of the screen from a projected direction of the projected video based on the distance; and
a zoom operation unit attached to the optical system which operations a zoom operation of the projected video.
